(19) United States
(12) Patent Application Publication
(10) Pub. No.: US 2018/0184703 A1
(43) Pub. Date: Jul. 5, 2018

(54) NOVEL EXTRUDATES

(71) Applicant: DSM IP ASSETS B.V., Heerlen (NL)

(72) Inventors: Camille ADLER, Kaiseraugst (CH); Martin KUENTZ, Kaiseraugst (CH); Alexandra TELEKI, Kaiseraugst (CH)

(21) Appl. No.: 15/740,567

(22) PCT Filed: Jul. 1, 2016
(86) PCT No.: PCT/EP2016/065477

§ 371 Date: Dec. 28, 2017

(30) Foreign Application Priority Data
Jul. 3, 2015 (EP) 15175172.4

(51) Int. Cl. A23P 30/20; A23K 20/174; A23K 20/158; A23K 20/179; A23K 40/25; A23L 33/115; A23L 33/155; A23L 33/15; A23L 33/16; A23K 20/28

(52) U.S. Cl. CPC A23P 30/20; A23K 20/174; A23K 20/158; A23K 20/179; A23K 40/25; A23V 2002/00; A23L 33/155; A23L 33/15; A23L 33/16; A23K 20/28; A23L 33/115

(57) ABSTRACT

The present invention relates to a process for producing specific extruded formulations (=extrudates), wherein the extruded formulations are comprising a high amount of fat-soluble compounds, to such formulations as well as to the use of such formulations in food, feed and personal care applications.

The present invention relates to an extrusion process for producing specific extruded formulations (=extrudates), wherein the extruded formulations are comprising a high amount of fat-soluble compounds; it also relates to such formulations as well as to the use of such formulations in food, feed and personal care applications.

There are many ways and processes to formulate fat soluble compounds.

Fat soluble compounds are for example oils and vitamins. The types of formulations are depending i.e. on the use of these formulations in the final application as well as on the kind of material (ingredients) which are used.

One way to formulate fat soluble compounds are dried emulsions or dried dispersions. The fat soluble compound is dispersed in an oil-in-water emulsion wherein the aqueous phase contains a matrix material and/or a suitable emulsifier. After drying, the fat soluble compound is embedded in the matrix material.

Known technologies for making emulsions/dispersions are e.g. rotor-stator-systems, high pressure homogenizers or ultrasonic devices. A major disadvantage of these technologies is that a relatively low viscosity (usually below 1 Pas) is required, leading to high amounts of water in the emulsionsdispersion, which needs then to be removed at the end of the process.

Extrusion processes (and extruders) are well known in the field of formulations. They can be used for many different kinds of materials. The technology was first used in the caoutchouc (natural gum) industry. But after some time, the food and feed industry adopted this technology for their purposes as well.

The main advantages of using the extrusion technology is that high viscous solutions can be formulated and less water (or even no water) can be used for the emulsion/dispersion, which then requires less drying after the extrusion to get the dried product. Dried product in the context of the present invention means that the water content is less than 5 weight-% (wt-%), based on the total weight of the extrudate.

Furthermore an extrusion process can be run as a continuous process.

Nowadays one limiting factor in the field of extrusion is the amount of the fat soluble compound which can be used and extruded. A high concentration of the fat soluble compound is desirable, because the fat soluble compound is the important ingredient (the active ingredient) in such a formulation. When the extrudate is higher concentrated (in regard to the active ingredient) it is better for its further use, because it needs less extrudate to formulate a final product.

With the commonly known processes (and compositions) of the prior art, the amount of the fat soluble compound cannot be increased significantly without deteriorating the quality (stability) of the obtained embodiment (extrudate).

The goal of the present invention was to find a way to produce extrudates with an increased amount of at least one fat soluble compound. The fat soluble compound(s) are for example lipids, carotenoids and/or fat-soluble vitamins.

Surprisingly it was found out that when at least one adsorbent material is added to the emulsion the amount of the fat-soluble compound(s) in the extrudate can be increased significantly.

Therefore the present invention relates to an extrusion process for producing extrudates, wherein a composition comprising at least one fat-soluble compound and at least 5 weight-%, based on the total weight of the extrudate, of at least one adsorbent, is extruded at a temperature of 50-300° C.

The term “lipids” covers oils, fats and waxes.

The adsorbent in the context of the present invention is a compound having the following properties:
high surface area (usually and preferably having a BET of at least 100 m²g⁻¹, up to 500 m²g⁻¹, preferred is a range of 200-400 m²g⁻¹ and 300-400 m²g⁻¹; the BET values are measured according to the method described in DIN-ISO 9277)
high oil adsorbing capacity (usually and preferably 1 ml/g-6 ml/g)
high porosity
functional groups that can interact with other excipients (e.g. silanol for H-bonding, cations for ion-dipole interactions)

A preferred group of adsorbents is the group of silicates, such as calcium silicate or magnesium aluminum silicate.

As fat soluble compounds any known and useful fat soluble compounds can be used. Fat soluble compounds are compounds soluble in non-polar substances (such as ether, chloroform and oils). Examples of fat soluble compounds are i.e. lipids, vitamins and carotenoids.

The lipids (oil, fat and wax) can be from any origin. They can be natural, modified or synthetic.

If the fats/oils are natural they can be plant or animal oils. Suitable oils are i.e. coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil, polyunsaturated fatty acids (such as triglyceride and/or ethyl ester, (for example arachidonic acid, eicosapentaenoic acid, docosahexaenoic acid and γ-linolenic acid and/or ethyl ester) and oily nutraceuticals (such as rosemary extract, oregano extract, hop extract, and other lipophilic plant extracts).

It is also suitable to use synthetic fats/oils, which are usually commercially available, such as polyethylene glycol, polyethylene oxide, mono-di-triglycerides, mono-diesters polyethylene glycol, polyethylene glycol 15 hydroxystearate, macrogolglycerides, glyceryl monostearate and glyceryl distearate.

Fat soluble vitamins such as vitamin A or its esters (for example vitamin A acetate and vitamin A palmitate), vitamin E or its esters (for example vitamin E acetate), vitamin K (phytomenadione) and vitamin D3 (cholecalciferol) are contemplated in the present invention. Such vitamins are readily available from commercial sources. Also, they may be prepared by conventional methods by a skilled person. Vitamins may be used in pure form, or in a suitable diluent such as a fat or oil.

The term “carotenoid” as used herein comprises a natural or synthetic carotene or structurally related polyene compound which can be used as a functional health ingredient or colorant for food, such as α- or β-carotene, 8′-apo-β-carotenal, 8′-apo-β-carotenoic acid esters such as the ethyl ester, canthaxanthin, astaxanthin, lycopene, lutein, zeaxanthin or crocetin, or mixtures thereof. The preferred carotenoids are β-carotene, lycopene and lutein and mixtures thereof, especially β-carotene.

Therefore a preferred embodiment of the present invention is related to an extrusion process for the production of an extrudate as described above, wherein the carotenoid is chosen from the group consisting of α-carotene, β-carotene, 8′-apo-β-carotenal, 8′-apo-β-carotenoic acid esters such as the ethyl ester, canthaxanthin, astaxanthin, lycopene, lutein, zeaxanthin and crocetin.

In an especially preferred extrusion process the carotenoid is β-carotene.

A preferred embodiment of the present invention relates an extrusion process as described above, wherein the fat soluble compound is a mixture of at least one lipid and at least one carotenoid.

Furthermore the extrudate usually comprises at least one polymeric carrier material. This carrier material can be natural as well as synthetic.

Suitable polymeric carrier material are polyethylene oxide; polyvinylpyrrolidon polypropylene oxide; polyvinylpyrrolidone-co-vinylacetate; acrylate and methacrylate copolymers; polyethylene; polycaprolactone; polyethylene-co-polypropylene; alkylcelluloses such as methylcellulose; hydroxyalkylcelluloses such as hydroxymethylcellulose, hydroxyethylcellulose, hydroxypropylcellulose (HPC), and hydroxybutylcellulose; hydroxyalkyl alkylcelluloses such as hydroxyethyl methylcellulose and hydroxypropyl methylcellulose; starches, pectins; polysaccharides such as tragacanth, gum arabic, guar gum, sucrose sterate, xanthan gum, mono, di, and tri glycerides, cetyl alcohol, steryl alcohol, and the like, polyolefins including xylitol, manitol, and sorbitol, alpha hydroxyl acids including citric and tartaric acid edipic acid meleaic acid malic acid, citric acid, enteric polymers such as CAP, HPMC AS, shellac, and a combination thereof.

Preferred polymeric carrier material in the context of the present invention are cellulose based polymers like ethyl cellulose (EC), hydroxypropylmethyl cellulose (HPMC), hydroxypropylcellulose (HPC) or alginate, chitosan, corn or potatoe starch are examples of the natural polymers. Polyvinylpyrrolidon (PVP), polyvinylacetate (PVA), polylactic acid (PLA) or copolymer like poly(methacrylic acid-co-ethyl acrylate) (Eudragit® from Evonik Industries) and polyvinyl caprolactam-polyvinyl acetate-polyethylene glycol graft copolymer (Soluplus® from BASF) are commonly used as synthetic polymers

All preferences for each compound as described above also applies for all the following embodiments.

A preferred embodiment is related to an extrusion process, wherein a composition comprising
(i) at least 5 weight-%, based on the total weight of the extrudate, of at least one adsorbent, and
(ii) at least 5 weight-%, based on the total weight of the extrudate, of at least one at least one lipid, and
(iii) at least 0.5 weight-%, based on the total weight of the extrudate, of at least one carotenoid (preferably β-carotene), and
(iv) at least 45 weight-%, based on the total weight of the extrudate, of at least one polymeric carrier material,
   is extruded at a temperature of 50-300° C.

A more preferred embodiment is related to an extrusion process, wherein a composition comprising
(i) at least 10 weight-%, based on the total weight of the extrudate, of at least one adsorbent, and
(ii) at least 10 weight-%, based on the total weight of the extrudate, of at least one at least one lipid, and
(iii) at least 1 weight-%, based on the total weight of the extrudate, of at least one carotenoid (preferably β-carotene), and
(iv) at least 50 weight-%, based on the total weight of the extrudate, of at least one polymeric carrier material,
   is extruded at a temperature of 50-300° C.

A further more preferred embodiment is related to an extrusion process, wherein a composition comprising
(i) 5-30 weight-%, based on the total weight of the extrudate, of at least one adsorbent, and
(ii) 5-20 weight-%, based on the total weight of the extrudate, of at least one at least one lipid, and
(iii) 0.5-10 weight-%, based on the total weight of the extrudate, of at least one carotenoid (preferably β-carotene), and
(iv) 50 -78 weight-%, based on the total weight of the extrudate, of at least one polymeric carrier material,
   is extruded at a temperature of 50-300° C.

All the percentages always add up to 100.

It is also possible to add further ingredients (auxiliary agents) to the composition, which is then extruded to form the extrudate. Such auxiliary agents can be useful for the extrusion process and/or for the extrudate and/or for the product (or application), wherein the extrudate is used afterwards.

Such auxiliary agents are for example antioxidants (such as ascorbic acid or salts thereof, tocopherol (synthetic or natural)); butylated hydroxytoluene (BHT); butylated hydroxyanisole (BHA); propyl gallate; tert. butyl hydroxyquinoline and/or ascorbic acid esters of a fatty acid); ethoxyquin; plasticisers; stabilisers; humectants (such as glycerine, sorbitol, polyethylene glycol); protective colloids; dyes, fragrances; fillers and buffers.

These auxiliary agents are added optionally. When added then the amount of the auxiliary agents goes from 0.1 to 50 weight-% (wt.-%), based on the total weight of the extrudate.

The extrudate according to the present invention are prepared by hot-melt extrusion.

Hot-melt extrusion processes are known from the prior art.

The term “hot-melt extrusion” is used herein to describe a process whereby an excipient blend is heated to a molten state and subsequently forced through an orifice where the extruded product is formed into its final shape in which it is solidified upon cooling. The blend is conveyed through various heating zones typically by a screw mechanism. The screw or screws are rotated by a variable speed motor inside a cylindrical barrel where only a small gap exists between the outside diameter of the screw and the inside diameter of the barrel. In this conformation, high shear is created at the barrel wall and between the screw fights by which the various components of the powder blend are well mixed and deaggregated. The hot-melt extrusion equipment is typically a single or twin-screw apparatus, but can be composed of more than two screw elements. A typical hot-melt extrusion apparatus contains a mixing/conveying zone, a heating/melting zone, and a pumping zone in succession up to the orifice. In the mixing/conveying zone, the powder blends are mixed and aggregates are reduced to primary particles by the shear force between the screw elements and the barrel. In the heating/melting zone, the temperature is at or above the melting point or glass transition temperature of the polymeric carrier in the blend such that the conveying solids become molten as they pass through the zone. The polymeric carrier acts as the matrix in which the active or actives and other functional ingredients are dispersed, or the adhesive with which they are bound such that a continuous composite is formed at the outlet orifice. Once in a molten state, the homogenized blend is pumped to the orifice through another heating zone that maintains the molten state of the blend. At the orifice, the molten blend can be formed into strands, cylinders or films. The extrudate that exits is then solidified typically by an air-cooling process. Once solidified, the extrudate may then be further processed to form pellets, spheres, fine powder, tablets, and the like.

Suitable extruders are for example KraussMaffei Berstorff, model ZE 25 UTX or Thermo Scientific Haake Polylab OS Rheodrive7/Haake Rheomex OS PTW 16.

Temperature is an important process variable to consider for the proposed invention.

The hot-melt extrusion process preferably employed is conducted at an elevated temperature, i. e. the heating zone(s) of the extruder is above room temperature (about 20° C.). It is important to select an operating temperature range that will minimize the degradation or decomposition of the compounds during processing. The operating temperature range is generally in the range of from about 50° C. to about 300° C. as determined by the setting for the extruder heating zone(s) and/or screw speed. The temperature of the mixture being hot-melt extruded will not exceed 300° C. and preferably will not exceed 250° C.

Therefore the present invention also relates to a hot-melt extrusion process for producing extrudates as described above, wherein the operating temperature range is generally in the range from about 50° C. to about 300° C. for the extruder heating zone(s), preferably the temperature of the mixture being hot-melt extruded will not exceed 300° C. and more preferably will not exceed 250° C.

All ingredients are used pure (no solvents added), placed into a mixer or hopper and agitated (blended) until thoroughly mixed. This mixture is then hot-melt extruded at a rate and temperature sufficient to melt or soften the polymeric carrier material, to minimize degradation of the components and to form an extrudate which is subsequently ground or chopped into suitable particles.

Consideration should be given to the manner in which the components of a formulation are fed to the extruder. In some embodiment, all formulation components are blended together to form a blended mixture before being fed to the extruder. This can be done by any traditional mixing or blending technique. Alternatively, formulation components may be fed individually if done simultaneously, and given that there is adequate mixing of the formulation components in the mixing/conveying zone of the extruder.

Usually and preferably no solvent is used in the hot-melt extrusion.

Many conditions can be varied during the extrusion process to arrive at a particularly advantageous formulation. Such conditions include, by way of example, formulation composition, feed rate, operating temperature, screw design, extruder screw RPM, residence time, die configuration, heating zone length and extruder torque and/or pressure. Methods for the optimization of such conditions are known to a person skilled in the art.

By including a plasticizer, and, optionally, an antioxidant, in a formulation, processing temperature, pressure and/or torque may be reduced. Plasticizers (as well as antioxidants) are not required in order to practice the invention. Their addition to the formulation is contemplated as being within the scope of the invention

A further embodiment of the present invention relates to extrudates obtained by the process described above.

The extrudates, which are obtained by the process according to the present invention as described above can be used as or in a food product, feed product and/or dietary supplement. This depends on the ingredients, which are used.

It is also possible to use the extrudates, which are obtained by the process according to the present invention in premix formulations, which are then used to formulate the final end-product.

Therefore the present invention also relates to the use of extrudates, which are obtained by the process according to the present invention in a food product, feed product and/or dietary supplement.

Therefore the present invention also relates a premix for a food product, feed product and/or dietary supplement comprising at least one extrudate which is obtained by the process according to the present invention as described above.

The invention is illustrated by the following Examples. All temperatures are given in ° C. and all parts and percentages are related to the weight.

### EXAMPLES

### Example 1

### Extrudate with Labrafac PG and Neusilin US2

The hot-melt extrusion (HME) process was performed with a Thermo Scientific Haake MiniLab II conical, co-rotating, twin-screw microcompounder. Hydroxypropylcellulose (HPC; Klucel EF Pharm; from Ashland), Labrafac PG (LPG; Propylene glycol dicaprylocaprate; from Gattefossé) and Neusilin US2 (US2; from Fuji Chemical Industry) were weighed and premixed at different ratios (see Table 1).

The premix was fed into the extruder. The temperature of the barrel was set to 180° C. The screw speed during the feeding step was set to 50 rpm followed by 250 rpm for 1 minute. The extrudate was then collected by opening the bypass valve of the extruder. The oil loading capacity was assessed by observing the presence of traces of oil on the strands surface and in the barrel. The addition of the adsorbent (Neusilin US2, which is fine ultra light granule of magnesium aluminometasilicate (CAS No 12511-31-8)), allowed increasing the oil load. Formulations containing 73/15/12 wt % (w/w) and 65/20/15 wt % of HPC/US2/LPG, respectively, did not show any traces of oil (Table 1).

TABLE 1
Composition of extrudates with increased lipid content.

| | Content Extrudate 1a, | Content Formulation 1b, |
|---|---|---|
| Ingredient | wt % | wt % |
| Hydroxypropyl- | 73 | 65 |
| cellulose | | |
| Labrafac PG | 12 | 15 |
| Neusilin US2 | 15 | 20 |

When the same process was used to produce extrudates without any adsorbent (only HPC and Labrafac PG), not more than 10 wt % of Labrafac PG could be added. A higher amount of the oil led to presence of oil droplets on the surface of the extrudates.

### Example 2

### Extrudate with Labrafac PG, Neusilin US2 and β-Carotene

The hot-melt extrusion (HME) process with the addition of crystalline β-carotene (BC, DSM Nutritional Products Ltd.) was performed as described in Example 1. The addition of BC to the formulation ingredients described in Example 1 was possible without leading to oily exdrutes. Typical formulations were composed of 70/15/12/3 wt % and 65/20/10/5 wt % of HPC/US2/LPG/BC, respectively (see Table 2).

TABLE 2
Composition of extrudates containing β-carotene.

| | Content Formulation 2a, | Content Formulation 2b, |
|---|---|---|
| Ingredient | wt % | wt % |
| Hydroxypropyl- | 70 | 65 |
| cellulose | | |
| Labrafac PG | 12 | 10 |
| Neusilin US2 | 15 | 20 |
| β-carotene | 3 | 5 |

### Example 3

### Extrudate with Compritol 888 ATO and Neusilin US2

The hot-melt extrusion (HME) process was performed with a Thermo Scientific Haake MiniLab II conical, co-rotating, twin-screw microcompounder. Hydroxypropylcellulose (HPC; Klucel EF; from Ashland), Compritol 888 ATO (Compritol; Glyceryl dibehenate; from Gattefossé) and Neusilin US2 (US2; from Fuji Chemical Industry) were weighed and premixed (see Table 3).

The premix was fed into the extruder. The temperature of the barrel was set to 180° C. The screw speed during the feeding step was set to 50 rpm followed by 250 rpm for 1 minute. The extrudate was then collected by opening the bypass valve of the extruder. The lipid loading capacity was assessed by observing the presence of traces of oil on the surface of the extrudates and in the barrel.

No oil traces could be observed on an extrudate containing 65/20/15 wt % of HPC/US2/Compritol.

TABLE 3
Composition of extrudate with increased lipid content.

| Ingredient | Content Formulation 3 |
|---|---|
| Hydroxypropyl- | 65 |
| cellulose | |
| Compritol 888 ATO | 15 |
| Neusilin US2 | 20 |

When the same process was used to produce extrudates without any adsorbent (only HPC and Compritol), not more than 10 wt % of Compritol could be added. A higher amount of the oil led to presence of oil droplets on the surface of the extrudates.

### Example 4

### Extrudate with Compritol 888 ATO, Neusilin US2 and β-Carotene

The hot-melt extrusion (HME) process with the addition of crystalline β-carotene (BC, DSM Nutritional Products Ltd.) was performed as described in Example 3. The addition of BC to the formulation ingredients described in Example 3 was possible without leading to oily strands. Typical formulations were composed of 64/18/15/3 wt % and 60/20/15/5 wt % (w/w) of HPC/US2/Compritol/BC. (see Table 4).

TABLE 4
Composition of extrudates containing β-carotene.

| | Content Formulation 4a, | Content Formulation 4b, |
|---|---|---|
| Ingredient | wt % | wt % |
| Hydroxypropyl- | 64 | 60 |
| cellulose | | |
| Compritol 888 ATO | 15 | 15 |
| Neusilin US2 | 18 | 20 |
| β-carotene | 3 | 5 |

### Example 5

### Extrudate with Compritol 888 ATO, Neusilin US2 and β-Carotene

The hot-melt extrusion (HME) process with the addition of crystalline β-carotene (BC, DSM Nutritional Products Ltd.) was performed as described in Example 3 but with less of the adsorbent. Oily Exdrutates were obtained when decreasing the Neusilin US2 content compared to formulations shown in Example 4.

### Example 6

### Extrudate with Stearic Acid and Neusilin US2

The hot-melt extrusion (HME) process was performed with a Thermo Scientific Haake MiniLab II conical, co-rotating, twin-screw microcompounder. Hydroxypropylcellulose (HPC; Klucel EF; from Ashland), Stearic acid (SA; from Sigma Aldrich) and Neusilin US2 (US2; from Fuji Chemical Industry) were weighed and premixed (s. table 5).

The premix was manually fed into the extruder. The temperature of the barrel was set to 180° C. .The screw speed during the feeding step was set to 50 rpm followed by 250 rpm for 1 minute. The extrudate was then collected by opening the bypass valve of the extruder. The lipid loading capacity was assessed by observing the presence of traces of oil on the strands surface and in the barrel. The extrudates composed of 65/20/15 wt % of HPC/US2/SA did not show oily traces.

TABLE 5
Composition of extrudate with increased lipid ratio.

| | Content Formulation 6, |
|---|---|
| Ingredient | wt % |
| Hydroxypropyl- | 65 |
| cellulose | |
| Stearic acid | 15 |
| Neusilin US2 | 20 |

When the same process was used to produce extrudates without any adsorbent (only HPC and Stearic acid), not more than 10 wt % of Stearic acid could be added. A higher amount led to presence of oil droplets on the surface of the extrudates. The addition of the adsorbent, allowed increasing the lipid load in the extrudates.

### Example 7

### Extrudates with Stearic Acid and Neusilin US2

The hot-melt extrusion (HME) process was performed as described in Example 6. It was found that Neusilin US2 inhibited recrystallization of stearic acid (SA) in the formulations (Table 6). In formulations composed of 70/20/10 wt % and 65/20/15 wt % of HPC/US2/SA, respectively, no SA crystalline peaks at around 26° (20) could be observed in the X-ray powder diffractograms (XRPD, Bruker D2 Phaser, fast linear 1-D Lynxeye detector, 1.8 kW Co KFL tube, Fe filter, 30 kV, 10 mA). Furthermore, Fourier transform infrared (FTIR) analysis confirmed the interactions between SA and US2. Dimer peaks in the region 1700-1500 cm⁻¹ were shifted and significantly vanished with increasing amount of US2 and a new peak appeared at 1585 cm⁻¹. The latter is characteristic of carboxylate formation. This showed that SA carboxylic group interacted with US2 silanol groups and also with aluminum and magnesium ions present on US2 surface. Furthermore, a disruption of the SA crystalline lattice could be confirmed by the FTIR analysis in agreement with the disappearance of SA crystalline peaks in the XRPD spectra.

TABLE 6
Composition of extrudates with no crystalline stearic acid.

| | Content Formulation 7a, | Content Formulation 7b, |
|---|---|---|
| Ingredient | wt % | wt % |
| Hydroxypropyl- | 65 | 70 |
| cellulose | | |
| Stearic acid | 15 | 10 |
| Neusilin US2 | 20 | 20 |

### Example 8

### Extrudates with Stearic Acid and Neusilin US2

The hot-melt extrusion (HME) process was performed as described in Example 6. It was found that stearic acid (SA) crystallinity prevailed a lower Neusilin US2 contents in the formulations compared to Example 7. In a formulation composed of 80/10/10 wt % of HPC/US2/SA, respectively, SA crystalline peaks at around 26° (20) could be observed in the X-ray powder diffractograms (XRPD, Bruker D2 Phaser, fast linear 1-D Lynxeye detector, 1.8 kW Co KFL tube, Fe filter, 30 kV, 10 mA).

### Example 9

### Extrudates with Stearic Acid, Neusilin US2 and β-Carotene

The hot-melt extrusion (HME) process with the addition of crystalline β-carotene (BC, DSM Nutritional Products Ltd.) was performed as described in Example 6 at 160, 170 and 180° C. The addition of BC to the formulation ingredients described in Example 6 was possible without leading to oily extrudates.

A typical extrudate was composed of 67/20/10/3 wt % of HPC/US2/SA/BC (Table 7). Furthermore, no BC crystalline peaks at around 17, 19, 20 and 22° (2θ) could be observed in the X-ray powder diffractograms (Bruker D2 Phaser, fast linear 1-D Lynxeye detector, 1.8 kW Co KFL tube, Fe filter, 30 kV, 10 mA) indicating an amorphous formulation of BC. This was valid for extrudates processed at all temperatures. BC content as well as degree of isomerization in the strand was assessed after extrusion by HPLC. The BC retention after the HME process at 160 or 180° C. was 87% and 73%, respectively. Thus the absence of BC crystalline peaks in the diffractograms was not due to high BC degradation. The all-trans content after the HME process at 160 or 180° C. was 45 and 31%, respectively.

TABLE 7
Composition of extrudate containing β-carotene.

| | Content Formulation 9, |
|---|---|
| Ingredient | wt % |
| Hydroxypropyl- | 67 |
| cellulose | |
| Stearic acid | 10 |
| Neusilin US2 | 20 |
| β-carotene | 3 |

In contrast, without Neusilin US2 (87/0/10/3 wt % HPC/US2/SA/BC, respectively), crystalline BC peaks were visible after extrusion at 160° C.

### Example 10

### Extrudates with Maisine 35-1 and Syloid XDP 3050

The hot-melt extrusion (HME) process was performed with a DSM Xplore MC5 conical, co-rotating, twin-screw microcompounder. Hydroxypropylcellulose (HPC; Klucel EF; from Ashland), Maisine 35-1 (M35-1; from Gattefossé), and Syloid XDP 3050 (SXDP; from Grace) were weighed and premixed with a spatula at different ratios. The premix was manually fed into the extruder. The temperature of the barrel was set to 160° C. The screw speed was set to 300 rpm during the feeding and the 1 minute mixing steps. The extrudate was then collected at a 200 rpm screw speed by opening the bypass valve of the extruder. The lipid loading capacity was assessed by observing the presence of traces of oil on the strands surface and in the barrel. In samples containing only HPC and LPG, a maximum of 10% lipid could be loaded. Higher lipid content leaded to a wet powder premix that was difficult to feed into the barrel and also resulted in oily strands. The addition of the adsorbent SXDP, allowed obtaining dry free-flowing powders and increasing the lipid load in the extrudates. Formulation composed of 78/12/10% and 55/25/20% HPC/SXDP/M35-1, respectively, were easy to feed and the strands did not show oily traces (Table 8).

TABLE 8
Composition of extrudate with increased lipid ratio

| | Content, | Content, |
|---|---|---|
| Ingredient | wt % | wt % |
| Hydroxypropyl- | 78 | 55 |
| cellulose | | |
| SXDP | 12 | 25 |
| M35-1 | 10 | 20 |

### Example 11

### Extrudate with Maisine 35-1 and Syloid XDP 3050, and β-Carotene

The hot-melt extrusion (HME) process with the addition of crystalline β-carotene (BC, DSM Nutritional Products Ltd.) was performed as described in Example 10. The addition of β-carotene to the formulation ingredients described in Example 1 was possible without leading to oily strands. Typical formulations were composed of 75/12/10/3%, 52/25/20/3%, 50/25/20/5% and 48/25/20/7% (w/w) HPC/SXDP/M35-1/BC, respectively (Table 11). Furthermore, no β-carotene crystalline peaks at around 17, 19, 20 and 22° (20) could be observed in the X-ray powder diffractograms (Bruker D2 Phaser, fast linear 1-D Lynxeye detector, 1.8 kW Co KFL tube, Fe filter, 30 kV, 10 mA) indicating an amorphous formulation of β-carotene. In contrast, without SXDP (87/0/10/3 HPC/SXDP/M35-1/BC, respectively), crystalline β-carotene peaks were visible after extrusion. β-carotene content as well as degree of isomerization in the strand was assessed after extrusion by HPLC. The β-carotene retention after the HME process was 75%. Thus the absence of β-carotene crystalline peaks in the diffractograms was not due to high β-carotene degradation. The all-trans content after the HME process was 35%.

TABLE 11
Composition of extrudate with increased lipid ratio.

| | Content, | Content, | Content, | Content, |
|---|---|---|---|---|
| Ingredient | wt % | wt % | wt % | wt % |
| Hydroxypropyl- | 75 | 52 | 50 | 48 |
| cellulose | | | | |
| Aeroperl 300 | 12 | 25 | 25 | 25 |
| Labrafac PG | 10 | 20 | 20 | 20 |
| β-carotene | 3 | 3 | 5 | 7 |

### Example 12

### Formulation with Labrafac PG, Aeroperl 300, and β-Carotene

The hot-melt extrusion (HME) process was performed with a DSM Xplore MC5 conical, co-rotating, twin-screw microcompounder. Hydroxypropylcellulose (HPC; Klucel EF; from Ashland), Labrafac PG (LPG; from Gattefossé), Aeroperl 300 (Aeroperl; from Evonik Industries), and β-carotene (BC, DSM Nutritional Products Ltd.) were weighed and premixed with a spatula at different ratios. The premix was manually fed into the extruder. The temperature of the barrel was set to 160° C. .The screw speed was set to 300 rpm during the feeding and the 1 minute mixing steps. The extrudate was then collected at a 200 rpm screw speed by opening the bypass valve of the extruder. The lipid loading capacity was assessed by observing the presence of traces of oil on the strands surface and in the barrel. In samples containing only HPC and LPG, a maximum of 10% lipid could be loaded. Higher lipid content leaded to a wet powder premix that was difficult to feed into the barrel and also resulted to oily strands. The addition of the adsorbent Aeroperl, allowed obtaining dry free-flowing powders and increasing the total lipid load (β-carotene and LPG) in the extrudates. Formulations composed of 75/12/10/3%, 70/15/10/5% and 65/18/10/7% (w/w) HPC/Aeroperl/LPG/β-carotene, respectively, were easy to feed and the strands did not show oily traces (Table 12). Furthermore, no β-carotene crystalline peaks at around 17, 19, 20 and 22° (2θ) could be observed in the X-ray powder diffractograms (Bruker D2 Phaser, fast linear 1-D Lynxeye detector, 1.8 kW Co KFL tube, Fe filter, 30 kV, 10 mA) indicating an amorphous formulation of β-carotene. In contrast, without SXDP (87/0/10/3 HPC/Aeroperl/LPG/β-carotene, respectively), crystalline β-carotene peaks were visible after extrusion. β-carotene content as well as degree of isomerization in the strand was assessed after extrusion by HPLC. The β-carotene retention after the HME process was >85%. Thus the absence of β-carotene crystalline peaks in the diffractograms was not due to high β-carotene degradation. The all-trans content after the HME process was >40%.

TABLE 12
Composition of extrudate with increased lipid ratio.

| | Content, | Content, | Content, |
|---|---|---|---|
| Ingredient | wt % | wt % | wt % |
| Hydroxypropyl- | 75 | 70 | 65 |
| cellulose | | | |
| Aeroperl 300 | 12 | 15 | 18 |
| Labrafac PG | 10 | 10 | 10 |
| β-carotene | 3 | 5 | 7 |

1. An extrusion process for producing an extrudate comprising at least one fat-soluble compound and at least 5 wt %, based on the total weight of the extrudate, of at least one adsorbent,
wherein a composition comprising the at least one fat-soluble compound and at least one adsorbent is extruded at a temperature of 50-300° C.

2. Extrusion process according to claim 1, wherein the adsorbent is a silicate, preferably calcium silicate and/or magnesium aluminum silicate.

3. Extrusion process according to claim 1, wherein the fat soluble compound is chosen from the group consisting of lipids, vitamins and carotenoids.

4. Extrusion process according to claim 3, wherein the lipid is an oil, a fat or a wax.

5. Extrusion process according to claim 4, wherein the lipid is chosen from the group coconut oil, corn oil, cottonseed oil, olive oil, palm oil, peanut oil, rapeseed oil, canola oil, safflower oil, sesame oil, soybean oil, sunflower oil, hazelnut oil, almond oil, cashew oil, macadamia oil, mongongo nut oil, pracaxi oil, pecan oil, pine nut oil, pistachio oil, sacha Inchi (Plukenetia volubilis) oil, walnut oil, polyunsaturated fatty acids (such as triglyceride and/or ethyl ester, oily nutraceuticals, polyethylene glycol, polyethylene oxide, mono-di-triglycerides, mono-diesters polyethylene glycol, polyethylene glycol 15 hydroxystearate, macrogolglycerides, glyceryl monostearate and glyceryl distearate.

6. Extrusion process according to claim 3, wherein the fat soluble vitamins is chosen from the group consisting of vitamin A or its esters (vitamin A acetate and vitamin A palmitate), vitamin E or its esters (vitamin E acetate), vitamin K (phytomenadione) and vitamin D3 (cholecalciferol).

7. Extrusion process according to claim 3, wherein wherein the carotenoid is chosen from the group consisting of α-carotene, β-carotene, 8′-apo-β-carotenal, 8′-apo-β-carotenoic esters such as the ethyl ester, canthaxanthin, astaxanthin, lycopene, lutein, zeaxanthin and crocetin.

8. Extrusion process according to claim 3, wherein the carotenoid is β-carotene.

9. Extrusion process according to claim 1, wherein the fat soluble compound is a mixture of at least one lipid and at least one carotenoid.

10. Extrusion process according to claim 1, wherein a composition comprising
(i) at least 5 weight-%, based on the total weight of the extrudate, of at least one adsorbent, and
(ii) at least 5 weight-%, based on the total weight of the extrudate, of at least one at least one lipid, and
(iii) at least 0.5 weight-%, based on the total weight of the extrudate, of at least one carotenoid (preferably (3-carotene), and
(iv) at least 45 weight-%, based on the total weight of the extrudate, of at least one polymeric carrier material,
is extruded.

11. Extrusion process according to claim 1, wherein a composition comprising
(i) at least 10 weight-%, based on the total weight of the extrudate, of at least one adsorbent, and
(ii) at least 10 weight-%, based on the total weight of the extrudate, of at least one at least one lipid, and
(iii) at least 1 weight-%, based on the total weight of the extrudate, of at least one carotenoid (preferably β-carotene), and
(iv) at least 50 weight-%, based on the total weight of the extrudate, of at least one polymeric carrier material,
is extruded.

12. Extrusion process according to claim 1, wherein a composition comprising
(i) 5-30 weight-%, based on the total weight of the extrudate, of at least one adsorbent, and
(ii) 5-20 weight-%, based on the total weight of the extrudate, of at least one at least one lipid, and
(iii) 0.5-10 weight-%, based on the total weight of the extrudate, of at least one carotenoid (preferably β-carotene), and
(iv) 50 -78 weight-%, based on the total weight of the extrudate, of at least one polymeric carrier material,
is extruded.

13. Extrudate obtained by a process according to claim 1.

14. Use of at least one of the extrudate obtained by a process according to claim 1 in a food product, feed product and/or dietary supplement.

15. Food product, feed product and/or dietary supplement comprising at least one extrudate obtained by a process according to claim 1.
